(19) United States
(12) Patent Application Publication
(10) Pub. No.: US 2025/0147838 A1
(43) Pub. Date: May 8, 2025

(54) EMBEDDED CONVERSATIONAL ARTIFICIAL INTELLIGENCE (AI)-BASED SMART APPLIANCES

(71) Applicant: International Business Machines Corporation, Armonk, NY (US)

(72) Inventors: Sanmitra Sarkar, Kolkata (IN); Mukundan Sundararajan, Bangalore (IN); Sumitro Ghatak, Kolkata (IN)

(21) Appl. No.: 18/504,022

(22) Filed: Nov. 7, 2023

(51) Int. Cl. G06F 11/07

(52) U.S. Cl. CPC G06F 11/0793; G06F 11/0709; G06F 11/079

(57) ABSTRACT

One embodiment of the invention provides a computer-implemented method for an interactive embedded conversational artificial intelligence (AI) agent on an electronic device. The method comprises obtaining a diagnostic report for the electronic device, establishing a communication channel with a remote chatbot, and sending, to the remote chatbot over the communication channel, the diagnostic report. The method further comprises receiving, from the remote chatbot over the communication channel, instructions for resolving at least one potential fault of the electronic device. The instructions are indicative of at least one potential fault of the electronic device and at least one preventative measure to resolve the at least one potential fault. The method further comprises dynamically taking at least one action to automatically resolve the at least one potential fault if the at least one potential fault is resolvable without human intervention. The at least one action is based on the instructions.

### BACKGROUND

The field of embodiments of the invention generally relate to smart appliances.

Smart appliances are machines or devices that have been designed to connect to the internet and to be controlled remotely. Examples of smart appliances include, but are not limited to, smart televisions, smart refrigerators, smart ovens, smart dishwashers, smart washers, smart dryers, etc.

A chatbot is software configured to conduct a conversation via auditory and/or textual methods (i.e., an automated conversational agent). Conversational artificial intelligence (AI) refers to technologies, like chatbots or virtual agents, which users can talk to.

### SUMMARY

Embodiments of the invention generally relate to smart appliances, and more specifically, an interactive embedded conversational artificial intelligence (AI) agent on a smart appliance.

One embodiment of the invention provides a computer-implemented method for an interactive embedded conversational AI agent on an electronic device. The method comprises obtaining a diagnostic report for the electronic device, establishing a communication channel with a remote chatbot, and sending, to the remote chatbot over the communication channel, the diagnostic report. The method further comprises receiving, from the remote chatbot over the communication channel, a set of instructions for resolving at least one potential fault of the electronic device. The set of instructions is indicative of at least one potential fault of the electronic device and at least one preventative measure to resolve the at least one potential fault. The method further comprises dynamically taking at least one action to automatically resolve the at least one potential fault if the at least one potential fault is resolvable without human intervention. The at least one action is based on the set of instructions. Other embodiments include a system for an interactive embedded conversational AI agent on an electronic device, and a computer program product for an interactive embedded conversational AI agent on an electronic device.

### BRIEF DESCRIPTION OF THE DRAWINGS

The subject matter which is regarded as embodiments of the invention are particularly pointed out and distinctly claimed in the claims at the conclusion of the specification. The foregoing and other objects, features, and advantages of embodiments of the invention are apparent from the following detailed description taken in conjunction with the accompanying drawings in which:

FIG. 1 depicts a computing environment according to an embodiment of the present invention;

FIG. 2 illustrates an example electronic device implementing an embedded conversational artificial intelligence (AI) agent, in accordance with an embodiment of the invention; and

FIG. 3 is a flowchart for an example process for an embedded conversational AI agent on an electronic device, in accordance with an embodiment of the invention.

The detailed description explains the preferred embodiments of the invention, together with advantages and features, by way of example with reference to the drawings.

### DETAILED DESCRIPTION

Embodiments of the invention generally relate to smart appliances, and more specifically, an interactive embedded conversational artificial intelligence (AI) agent on a smart appliance. One embodiment of the invention provides a computer-implemented method for an interactive embedded conversational AI agent on an electronic device. The method comprises obtaining a diagnostic report for the electronic device, establishing a communication channel with a remote chatbot, and sending, to the remote chatbot over the communication channel, the diagnostic report. The method further comprises receiving, from the remote chatbot over the communication channel, a set of instructions for resolving at least one potential fault of the electronic device. The set of instructions is indicative of at least one potential fault of the electronic device and at least one preventative measure to resolve the at least one potential fault. The method further comprises dynamically taking at least one action to automatically resolve the at least one potential fault if the at least one potential fault is resolvable without human intervention. The at least one action is based on the set of instructions.

Another embodiment provides a system for an interactive embedded conversational AI agent on an electronic device. The system comprises at least one processor and a processor-readable memory device storing instructions that when executed by the at least one processor causes the at least one processor to perform operations. The operations include obtaining a diagnostic report for the electronic device, establishing a communication channel with a remote chatbot, and sending, to the remote chatbot over the communication channel, the diagnostic report. The operations further include receiving, from the remote chatbot over the communication channel, a set of instructions for resolving at least one potential fault of the electronic device. The set of instructions is indicative of at least one potential fault of the electronic device and at least one preventative measure to resolve the at least one potential fault. The operations further include dynamically taking at least one action to automatically resolve the at least one potential fault if the at least one potential fault is resolvable without human intervention. The at least one action is based on the set of instructions.

One embodiment of the invention provides a computer program product for an interactive embedded conversational AI agent on an electronic device. The computer program product comprises a computer readable storage medium having program instructions embodied therewith. The program instructions are executable by a processor to cause the processor to obtain a diagnostic report for the electronic device, establish a communication channel with a remote chatbot, and send, to the remote chatbot over the communication channel, the diagnostic report. The program instructions are executable by the processor to further cause the processor to receive, from the remote chatbot over the communication channel, a set of instructions for resolving at least one potential fault of the electronic device. The set of instructions is indicative of at least one potential fault of the electronic device and at least one preventative measure to resolve the at least one potential fault. The program instructions are executable by the processor to further cause the processor to dynamically take at least one action to automatically resolve the at least one potential fault if the at least one potential fault is resolvable without human intervention. The at least one action is based on the set of instructions.

In at least some embodiments, at least one troubleshooting step is provided to a human agent to assist the human agent with resolving the at least one potential fault if the at least one potential fault is not resolvable without human intervention. The at least one troubleshooting step is based on the set of instructions.

In at least some embodiments, an inspection of at least one faulty component of the electronic device is performed.

In at least some embodiments, an incident involving the at least one faulty component is reported to a remote helpdesk if the at least one faulty component is not resolvable without human intervention.

In at least some embodiments, one or more actions to automatically resolve the at least one faulty component are dynamically taken if the at least one faulty component is resolvable without human intervention.

In at least some embodiments, a context of a conversation with a user is evaluated to determine whether the context has changed during the conversation. If the context has changed, a revised set of operating procedures is obtained, the user is provided with information identifying at least one of a new context of the conversation, at least one risk associated with the new context, or the revised set of standard operating procedures, and one or more actions are dynamically taken or one or more existing instruction sequences are overridden in accordance with the revised set of operating procedures if the at least one risk is resolvable without human intervention. The revised set of operating procedures is either predicted by the remote chatbot or retrieved from at least one other embedded conversational AI agent.

In at least some embodiments, the at least one potential fault is predicted by a machine learning model utilized by the remote chatbot.

In at least some embodiments, a periodical report indicative of an overall health of the electronic device is received from the remote chatbot over the communication channel. The overall health is predicted by a machine learning model utilized by the remote chatbot.

Today's smart appliances are embedded with a large number of functions. A function embedded in a smart appliance is typically instantiated by a user calling out a simple instruction sequence which in turn triggers execution of a set of complex instruction sequences at the smart appliance. An example function embedded in a smart appliance is a chatbot.

A chatbot is a conversational agent within an operating system of a machine/device. A chatbot is typically configured to receive questions from users and provide solutions to the questions by interacting with at an original equipment manufacturer (OEM) of the machine/device for customer service/technical support, a subject matter expert (SME), or, in some cases, social media. However, there are several instances where users want a small variation to the manner in which a chatbot provides solutions, but such variations are either not allowed or attempted by others. Some users may try to experiment a number of times (from 1 up to n times) before settling for a working instruction sequence and carrying out adjustments outside of preset instruction sequences. Even if chatbots on machines/devices that can take care of backend interactions exist, there is a need for such chatbots to be able to determine an intersection between a user expectation (that a user calls out), operating conditions, and an explanation to the backend.

One or more embodiments of the invention provide a framework for implementing an interactive embedded conversational AI agent on an electronic device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

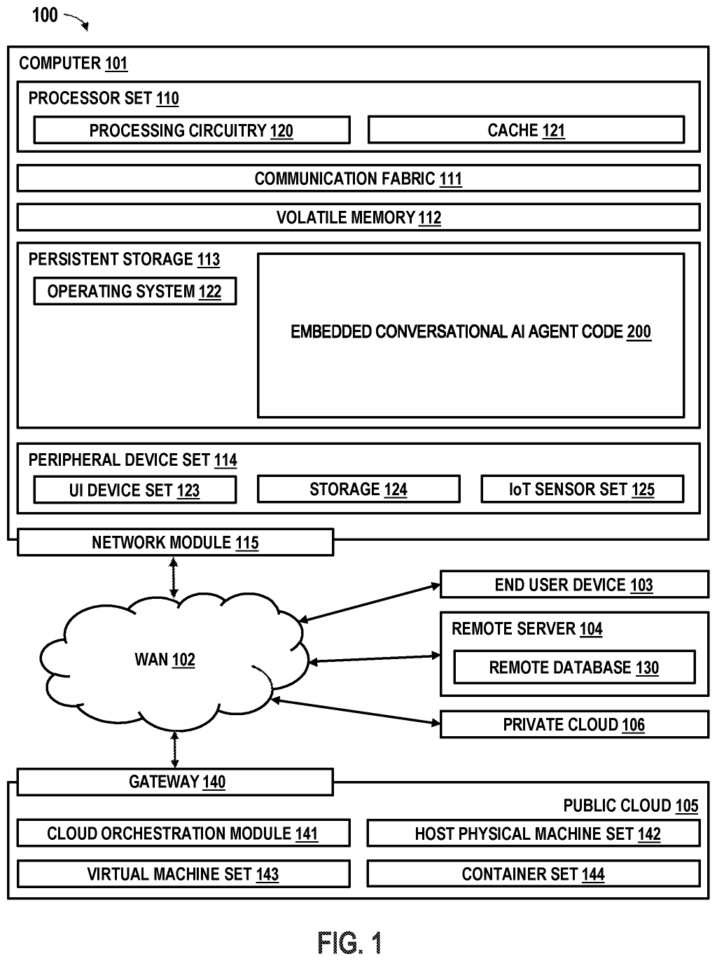

FIG. 1 depicts a computing environment 100 according to an embodiment of the present invention. Computing environment 100 contains an example of an environment for the execution of at least some of the computer code involved in performing the inventive methods, such as an embedded conversational AI agent code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

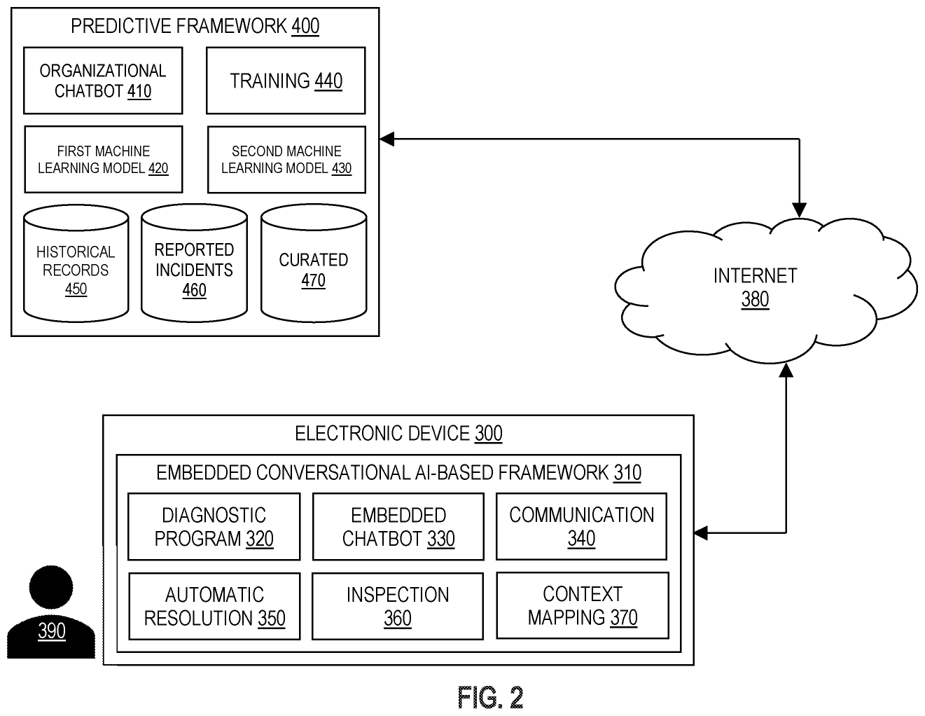

FIG. 2 illustrates an example electronic device 300 implementing an embedded conversational AI agent (“embedded chatbot”) 330, in accordance with an embodiment of the invention. The electronic device 300 comprises an embedded conversational AI-based framework 310. In some embodiments, the framework 310 is representative of the block 200 shown in FIG. 1.

Examples of an electronic device 300 include, but are not limited to, a desktop computer, a mobile electronic device (e.g., a tablet, a smart phone, a laptop, etc.), a wearable device (e.g., a smart watch, etc.), an IoT device, a smart appliance such as a smart television, a smart refrigerator, a smart oven, a smart dishwasher, a smart washer, a smart dryer, etc.

In some embodiments, the framework 310 comprises a diagnostic program 320 configured to: (1) execute/run a system diagnostics profile on the electronic device 300, and (2) generate a diagnostic report for the electronic device 300, wherein the diagnostic report comprises results of executing/running the system diagnostics profile. The diagnostic program 320 is an automatic computer program sequence that determines operational status and/or detects faults within software, hardware, or any combination thereof in the electronic device 300. The diagnostic report comprises information indicative of each operational status determined and/or each defect/fault/issue detected by the diagnostic program 320. For example, the diagnostic report is indicative of internal details and/or usage of the electronic device 300. In some embodiments, the framework 310 is configured to execute/run the diagnostic program 320 daily.

In some embodiments, the framework 310 comprises the embedded chatbot 330. The embedded chatbot 330 is an on-board (i.e., on-device) chatbot that executes/runs on the electronic device 300. The embedded chatbot 330 is configured to: (1) conduct a conversational interaction (i.e., a speech-based and/or text-based conversation) with a user 390 (e.g., a customer), (2) determine a context of the conversational interaction, and (3) direct the conversational interaction based on the context.

In some embodiments, the framework 310 comprises a communication unit 340 configured to establish a communication channel between the embedded chatbot 330 and an organizational chatbot 410 over the internet 380 (e.g., the WAN 102 shown in FIG. 1). The communication channel provides end-to-end communication between the embedded chatbot 330 and the organizational chatbot 410. The embedded chatbot 330 is able to communicate continuously with the organizational chatbot 410 via the communication channel.

In some embodiments, the organizational chatbot 410 is a chatbot instance spawned by a predictive framework 400 executing/running remotely (e.g., on a remote server 104, a private cloud 106, or a public cloud 105 shown in FIG. 1). In some embodiments, the predictive framework 400 is operated by an organization such as, but not limited to, a product manufacturer or OEM of the electronic device 300, a SME, etc.

In some embodiments, the embedded chatbot 330 is configured to: (1) obtain a diagnostic report for the electronic device 300 (e.g., from the diagnostic program 320), (2) trigger the communication unit 340 to establish the communication channel between the embedded chatbot 330 and the organizational chatbot 410 over the internet 380, and (3) exchange the diagnostic report with the organizational chatbot 410 via the communication channel.

In some embodiments, the organizational chatbot 410 is configured to: (1) receive a diagnostic report for the electronic device 300 from the embedded chatbot 330 via the communication channel, (2) provide the diagnostic report as input to a first machine learning model 420 trained to predict potential defects/faults/issues of electronic devices 300, (3) receive a prediction output from the first machine learning model 420, wherein the prediction comprises one or more predicted potential defects/faults/issues of the electronic device 300 and one or more preventative measures that may be taken to address the predicted potential defects/faults/issues, and (4) provide, based on the prediction, a set of instructions to the embedded chatbot 330 to resolve the predicted potential defects/faults/issues. In some embodiments, the first machine learning model 420 comprises a deep learning model, such as a neural network.

In some embodiments, the organizational chatbot 410 is configured to: (1) provide the diagnostic report as input to a second machine learning model 430 trained to predict overall health of electronic devices 300, (2) receive a periodical report output from the second machine learning model 430, wherein the periodical report comprises a predicted overall health of the electronic device 300, and (3) provide the periodical report to the user 390 or, alternatively, to the embedded chatbot 330 which in turn provides the same to the user 390. In some embodiments, the second machine learning model 430 comprises a deep learning model, such as a neural network.

In some embodiments, the framework 310 comprises an automatic resolution unit 350 configured to perform automatic resolution. Automatic resolution is a process that involves the embedded chatbot 330 dynamically taking one or more actions to automatically resolve one or more predicted potential defects/faults/issues of the electronic device 300 without any human intervention, i.e., the electronic device 300 “self-repairs” or “self-heals” via the embedded chatbot 330 without requiring intervention by a human agent (e.g., the user 390 or a technician).

In some embodiments, in response to receiving from the organizational chatbot 410 a set of instructions to resolve one or more predicted potential defects/faults/issues of the electronic device 300, the embedded chatbot 330 determines, based on the instructions, whether automatic resolution to resolve the predicted potential defects/faults/issues is possible. If automatic resolution to resolve the predicted potential defects/faults/issues is possible, the embedded chatbot 330 triggers the automatic resolution unit 350 to perform automatic resolution. Therefore, the embedded chatbot 330 is interactive in nature, such that it can take actions that “self-repair” or “self-heal”.

If automatic resolution to resolve the predicted potential defects/faults/issues is not possible, the embedded chatbot 330 requests intervention from a human agent (e.g., the user 390 or a technician) to resolve the predicted potential defects/faults/issues (i.e., human intervention is required). For example, in some embodiments, the embedded chatbot 330 provides one or more troubleshooting steps to the human agent to assist the human agent with resolving the predicted potential defects/faults/issues. As another example, in some embodiments, the embedded chatbot 330 provides the user 390 with a message warning of the predicted potential defects/faults/issues, and sends an alert to a technician requesting the technician to perform repairs on the electronic device 300 to resolve the predicted potential defects/faults/issues.

In some embodiments, the framework 310 comprises an inspection unit 360 configured to perform an inspection of one or more faulty components (e.g., software, hardware, or any combination thereof) of the electronic device 300. A faulty component of the electronic device 300 may be identified based on a diagnostic report (e.g., from the diagnostic program 320) or a set of instructions to resolve one or more predicted potential defects/faults/issues of the electronic device 300 (e.g., from the organizational chatbot 410).

In some embodiments, the embedded chatbot 330 is configured to: (1) trigger the inspection unit 360 to perform an inspection of one or more faulty components of the electronic device 300, and (2) raise/report an incident involving the faulty components with customer service/technical support (e.g., a helpdesk or social media account of a product manufacturer or OEM of the electronic device 300, a SME, etc.). For example, in some embodiments, the embedded chatbot 330 raises/reports the incident by: (1) sending an electronic communication (e.g., email, text message) identifying the faulty components to a pre-determined address (e.g., email address) for the customer service/technical support, (2) receiving a tracking number assigned to the incident from the customer service/technical support, and (3) providing the tracking number to the user 390 for their reference.

In some embodiments, the embedded chatbot 330 determines whether automatic resolution to resolve the faulty components is possible. In some embodiments, the embedded chatbot 330 informs the user 390 whether the faulty components can be resolved via automatic resolution or requires intervention from a human agent. If automatic resolution to resolve the faulty components is possible, the embedded chatbot 330 triggers the automatic resolution unit 350 to perform the automatic resolution. Therefore, the embedded chatbot 330 is interactive in nature, such that it can take actions that “self-repair” or “self-heal”. The entire process from raising/reporting the incident to resolving the incident is automated for faster turnaround. This is unlike conventional embedded chatbots that are not interactive in nature—these conventional embedded chatbots cannot take actions that “self-repair” or “self-heal”, and a user has to take the initiative to raise/report an incident involving a faulty component with customer service/technical support.

In some embodiments, the framework 310 comprises a mapping unit 370 configured to perform context mapping. Context mapping is a process which involves a re-evaluation of ad-hoc context of a conversational interaction (i.e., conversation) between the embedded chatbot 330 and the user 390 to determine whether an original context of the conversational interaction has evolved to a new context, i.e., whether there is an ad-hoc context-driven change during the conversational interaction. An example of an ad-hoc context-driven change is a reference or a sentence by the user 390 that does not have any relationship to the original context.

In some embodiments, the context mapping unit 370 performs context mapping by applying one or more natural language processing (NLP) techniques to determine a similarity index between an original context and a current context (i.e., evolving context) of a conversational interaction between the embedded chatbot 330 and the user 390. If the similarity index is less than a pre-determined similarity threshold (e.g., less than 80%), the original context and the current context (i.e., evolving context) are dissimilar, and there is an ad-hoc context-driven change. If the similarity index is equal to or more than the pre-determined similarity threshold (e.g., equal to or more than 80%), the original context and the current context (i.e., evolving context) are similar, and there is no ad-hoc context-driven change.

In some embodiments, the embedded chatbot 330 is configured to continuously analyze a conversational interaction with the user 390 by triggering the context mapping unit 370 to perform context mapping. If there is an ad-hoc context-driven change during the conversational interaction, the embedded chatbot 330 determines that a current context (i.e., evolving context) of the conversational interaction is now a new context of the conversational interaction, and provides the user 390 with context information identifying the ad-hoc context-driven change.

In some embodiments, the embedded chatbot 330 provides the user 390 with risk information identifying one or more risks associated with the new context. For each of the risks associated with the new context, the risk information further identifies whether the risk can be resolved via automatic resolution or requires intervention from a human agent. Therefore, the embedded chatbot 330 is able to pivot a conversation with the user 390 in the event of ad-hoc context-driven changes.

In some embodiments, the embedded chatbot 330 obtains a revised set of operating procedures for the electronic device 300 based on the new context, and provides the user 390 with the revised set of operating procedures. If the risks associated with the new context are resolvable without human intervention, the revised set of standard operating procedures triggers the embedded chatbot 330 to take one or more actions or override one or more existing instruction sequences. For example, in some embodiments, if the risks associated with the new context exceed a pre-determined risk threshold, the embedded chatbot 330 overrides one or more existing instruction sequences.

In some embodiments, the revised set of standard operating procedures is predicted by the organizational chatbot 410 based on one or more of its interactions with one or more other embedded chatbots 330 of one or more other electronic devices 300. In some embodiments, the revised set of standard operating procedures is retrieved from another embedded chatbot 330 of another electronic device 300, wherein a context of a conversational interaction between the other embedded chatbot 330 and another user 390 is similar to the new context.

Context mapping allows the embedded chatbot 330 to take action in a dynamic scenario where a context of a conversational interaction changes, re-assess risk, and override existing instruction sequences if necessary.

In some embodiments, the predictive framework 400 maintains at least the following: (1) a historical records database 450 comprising historical records from similar electronic devices 300 (e.g., similar electronic devices 300 from the same product manufacturer or OEM) which had similar faulty components (e.g., similar system failures), (2) a reported incidents database 460 comprising incidents raised by/reported from the electronic device 300 to customer service/technical support (e.g., raised/reported by the embedded chatbot 330 or the user 390), and (3) a curated database 470 comprising a dataset curated by SMEs (e.g., engineers, industry experts, etc.) and highlighting potential defects/faults/issues that might be associated with specific types of electronic devices 300.

In some embodiments, the predictive framework 400 comprises a training unit 440 configured to train each machine learning model 420, 430. Specifically, for each machine learning model 420, 430, the training unit 440 creates corresponding training data using training samples from the historical records database 450, the reported incidents database 460, and the curated database 470, and trains the machine learning model 420, 430 using the corresponding training data.

In some embodiments, for the first machine learning model 420, the training unit 440 uses one or more oversampling techniques (e.g., Synthetic Minority Oversampling Technique (SMOTE)) to create corresponding training data that is balanced as actual failure rates may be low in real-word data. The resulting trained first machine learning model 420 is configured to: (1) receive, as input, a diagnostic report from an electronic device 300, and (2) predict, at a granular level, the following: (2-a) one or more potential defects/faults/issues, at an equipment level, of the electronic device 300 that may affect performance of electronic device 300, and (2-b) one or more preventative measures that may be taken to address the predicted potential defects/faults/issues.

The resulting trained second machine learning model 430 is configured to: (1) receive, as input, a diagnostic report from an electronic device 300, and (2) predict an overall health of an electronic device 300 based on multiple system parameters (e.g., from the diagnostic report) of the electronic device 300.

Unlike conventional embedded chatbots, the embedded chatbot 330 has access to the predictive capabilities of the machine learning models 420, 430 via the organizational chatbot 410. Further, each set of instructions and/or revised set of operating procedures the embedded chatbot 330 receives from the organizational chatbot 410 is fact-derived (i.e., based on a diagnostic report for the electronic device 300) and context adapted (i.e., accounts for any ad-hoc context-driven changes).

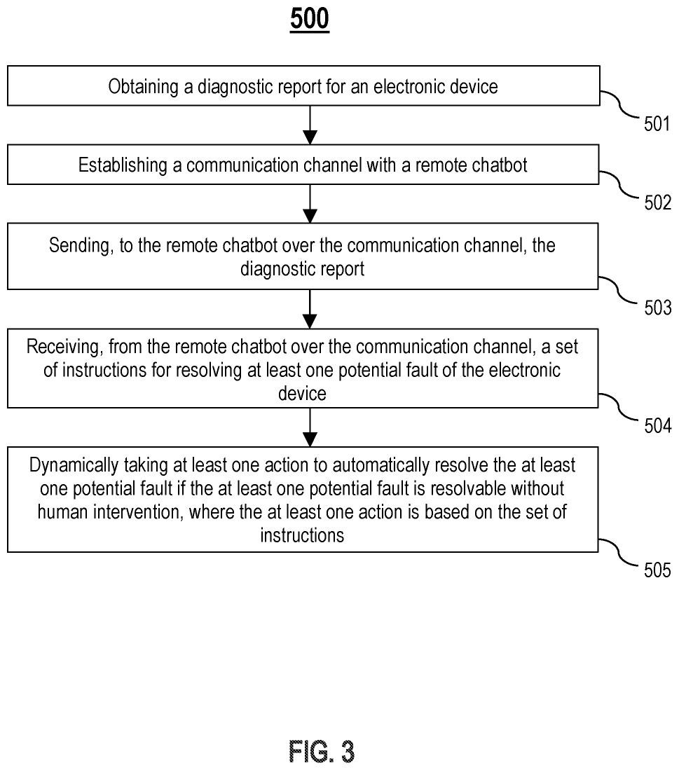

FIG. 3 is a flowchart for an example process 500 for an embedded conversational AI agent (e.g., embedded chatbot 330) on an electronic device (e.g., electronic device 300), in accordance with an embodiment of the invention. Process block 501 includes obtaining a diagnostic report for the electronic device. Process block 502 includes establishing a communication channel with a remote chatbot (e.g., organizational chatbot 410). Process block 503 includes sending the diagnostic report to the remote chatbot over the communication channel. Process block 504 includes receiving a set of instructions from the remote chatbot over the communication channel, where the set of instructions is indicative of at least one potential fault of the electronic device and at least one preventative measure to resolve the at least one potential fault. Process block 505 includes dynamically taking at least one action to automatically resolve the at least one potential fault if the at least one potential fault is resolvable without human intervention, where the at least one action is based on the set of instructions.

In some embodiments, process blocks 501-505 are performed by one or more components of the framework 310.

From the above description, it can be seen that embodiments of the invention provide a system, computer program product, and method for implementing the embodiments of the invention. Embodiments of the invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. § 112 (f), unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for an interactive embedded conversational artificial intelligence (AI) agent on an electronic device, comprising:
obtaining a diagnostic report for the electronic device;
establishing a communication channel with a remote chatbot;
sending, to the remote chatbot over the communication channel, the diagnostic report;
receiving, from the remote chatbot over the communication channel, a set of instructions for resolving at least one potential fault of the electronic device; and
dynamically taking at least one action to automatically resolve the at least one potential fault if the at least one potential fault is resolvable without human intervention, wherein the at least one action is based on the set of instructions.

2. The computer-implemented method of claim 1, further comprising:
providing at least one troubleshooting step to a human agent to assist the human agent with resolving the at least one potential fault if the at least one potential fault is not resolvable without human intervention, wherein the at least one troubleshooting step is based on the set of instructions.

3. The computer-implemented method of claim 1, further comprising:
performing an inspection of at least one faulty component of the electronic device.

4. The computer-implemented method of claim 3, further comprising:
reporting an incident involving the at least one faulty component to a remote helpdesk if the at least one faulty component is not resolvable without human intervention.

5. The computer-implemented method of claim 3, further comprising:
dynamically taking one or more actions to automatically resolve the at least one faulty component if the at least one faulty component is resolvable without human intervention.

6. The computer-implemented method of claim 1, further comprising:
evaluating a context of a conversation with a user to determine whether the context has changed during the conversation; and
if the context has changed:
obtaining a revised set of operating procedures, wherein the revised set of operating procedures is either predicted by the remote chatbot or retrieved from at least one other embedded conversational AI agent;
providing the user with information identifying at least one of a new context of the conversation, at least one risk associated with the new context, or the revised set of standard operating procedures; and
dynamically taking one or more actions or overriding one or more existing instruction sequences in accordance with the revised set of operating procedures if the at least one risk is resolvable without human intervention.

7. The computer-implemented method of claim 1, wherein the at least one potential fault is predicted by a machine learning model utilized by the remote chatbot.

8. The computer-implemented method of claim 1, further comprising:
receiving, from the remote chatbot over the communication channel, a periodical report indicative of an overall health of the electronic device, wherein the overall health is predicted by a machine learning model utilized by the remote chatbot.

9. A system for an interactive embedded conversational artificial intelligence (AI) agent on an electronic device, comprising:
at least one processor; and
a processor-readable memory device storing instructions that when executed by the at least one processor causes the at least one processor to perform operations including:
obtaining a diagnostic report for the electronic device;
establishing a communication channel with a remote chatbot;
sending, to the remote chatbot over the communication channel, the diagnostic report;
receiving, from the remote chatbot over the communication channel, a set of instructions for resolving at least one potential fault of the electronic device; and
dynamically taking at least one action to automatically resolve the at least one potential fault if the at least one potential fault is resolvable without human intervention, wherein the at least one action is based on the set of instructions.

10. The system of claim 9, wherein the operations further include:
providing at least one troubleshooting step to a human agent to assist the human agent with resolving the at least one potential fault if the at least one potential fault is not resolvable without human intervention, wherein the at least one troubleshooting step is based on the set of instructions.

11. The system of claim 9, wherein the operations further include:
performing an inspection of at least one faulty component of the electronic device.

12. The system of claim 11, wherein the operations further include:
reporting an incident involving the at least one faulty component to a remote helpdesk if the at least one faulty component is not resolvable without human intervention.

13. The system of claim 11, wherein the operations further include:
dynamically taking one or more actions to automatically resolve the at least one faulty component if the at least one faulty component is resolvable without human intervention.

14. The system of claim 9, wherein the operations further include:
evaluating a context of a conversation with a user to determine whether the context has changed during the conversation; and
if the context has changed:
obtaining a revised set of operating procedures, wherein the revised set of operating procedures is either predicted by the remote chatbot or retrieved from at least one other embedded conversational AI agent;
providing the user with information identifying at least one of a new context of the conversation, at least one risk associated with the new context, or the revised set of standard operating procedures; and
dynamically taking one or more actions or overriding one or more existing instruction sequences in accordance with the revised set of operating procedures if the at least one risk is resolvable without human intervention.

15. The system of claim 9, wherein the at least one potential fault is predicted by a machine learning model utilized by the remote chatbot.

16. The system of claim 9, wherein the operations further include:
receiving, from the remote chatbot over the communication channel, a periodical report indicative of an overall health of the electronic device, wherein the overall health is predicted by a machine learning model utilized by the remote chatbot.

17. A computer program product for an interactive embedded conversational artificial intelligence (AI) agent on an electronic device, the computer program product comprising a computer readable storage medium having program instructions embodied therewith, the program instructions executable by a processor to cause the processor to:
obtain a diagnostic report for the electronic device;
establish a communication channel with a remote chatbot;
send, to the remote chatbot over the communication channel, the diagnostic report;
receive, from the remote chatbot over the communication channel, a set of instructions for resolving at least one potential fault of the electronic device; and
dynamically take at least one action to automatically resolve the at least one potential fault if the at least one potential fault is resolvable without human intervention, wherein the at least one action is based on the set of instructions.

18. The computer program product of claim 17, wherein the program instructions executable by the processor further cause the processor to:
provide at least one troubleshooting step to a human agent to assist the human agent with resolving the at least one potential fault if the at least one potential fault is not resolvable without human intervention, wherein the at least one troubleshooting step is based on the set of instructions.

19. The computer program product of claim 17, wherein the program instructions executable by the processor further cause the processor to:
perform an inspection of at least one faulty component of the electronic device.

20. The computer program product of claim 19, wherein the program instructions executable by the processor further cause the processor to:
report an incident involving the at least one faulty component to a remote helpdesk if the at least one faulty component is not resolvable without human intervention.
